(19) United States
(12) Patent Application Publication
(10) Pub. No.: US 2009/0304998 A1
(43) Pub. Date: Dec. 10, 2009

(54) FILM ROLL

(75) Inventors: Yukio Nakagawa, Ritto-shi (JP); Yoshio Iwasaki, Ritto-shi (JP); Taro Hijikata, Ritto-shi (JP)

Correspondence Address: GLOBAL IP COUNSELORS, LLP, 1233 20TH STREET, NW, SUITE 700, WASHINGTON, DC, 20036-2680, US

(73) Assignee: ISHIDA CO., LTD., Kyoto (JP)

(21) Appl. No.: 11/574,577

(22) PCT Filed: Jan. 13, 2006
(86) PCT No.: PCT/JP06/00337

§ 371 Date: Aug. 17, 2009

(30) Foreign Application Priority Data
Jan. 17, 2005 (JP) 2005-008560

(51) Int. Cl. B32B 3/02

(52) U.S. Cl. 428/157

(57) ABSTRACT

A film roll is provided in which the terminal end of the film can be temporarily held in place and easily peeled off without damaging the film. A film roll (9), which is formed by winding a length of film (F) around a paper tube (9a) and is automatically loaded into a bag packaging machine (3), is provided with an adhesive member (9b) on a portion thereof within 10-20 mm from a terminal end (F1) of the film (F), and between the reverse side of a portion of the terminal end (F1) and the front side of a portion of the film (F) on which the portion of the terminal end (F1) overlaps. The adhesive member (9b) is formed so as to increase in thickness from the inside of the film (F) toward the terminal end (F1).

### TECHNICAL FIELD

The present invention relates to a film roll to be loaded into a packaging machine as a roll unit, in which a packaging material such as a plastic film or the like used for packaging food and other products is wound.

### BACKGROUND ART

A packaging machine has been conventionally used in which film is pulled out from a film roll formed by winding a length of film made of resin, and products such as food products are packaged with the film.

For example, patent document 1 discloses a packaging machine in which a film roll is loaded and products are packaged. With this machine, a terminal end of the film F at the outermost convolution of the film roll (see F101 in FIG. 11(a)) is a free end, i.e., the end is not held in place (see FIG. 3 of patent document 1). This document describes a mechanism in which the free terminal end of the film hanging down from the loaded film roll is guided to a predetermined position by means of a guide board. However, when the terminal end of the film is a free end as described above, it can cause a problem when the film roll is automatically loaded into the packaging machine.

To address this problem, a method for holding the terminal end of the film on the roll side by using an adhesive tape and the like has been adopted (see 109b of FIG. 11(b)) as a method for temporarily holding the terminal end of the film of a film roll on the roll side. However, when the terminal end of the film is temporarily held in place by using an adhesive tape and the like, the terminal end not being a free end poses no problem until the film is in use (during automatically loading of the film and the like), but it has been very difficult to have the packaging machine mechanically peel off the adhesive tape when the terminal end of the film needs to be pulled out from the film roll in order to be used. Therefore, the adhesive tape needs to be peeled off manually, and it may be an obstacle in terms of facilitating a complete automation of the packaging machine, such as automatic film roll loading and automatic film splicing.

Patent document 2 discloses a film roll in which the terminal end of the film is held in place and is easily peeled off the same when using the film (see the second and third figures in patent document 2). This film roll has an opening that is formed at a predetermined distance away from the terminal end of the film, and a tape is attached so as to cover the opening. Accordingly, since the terminal end of the film is not temporarily held in place, the terminal end of the film can be easily peeled off from the film roll, compared to a film roll in which the terminal end of the film is held in place by adhesive tape and the like.

Patent Document 1

JP-A Publication No. H08-9441 (published on Jan. 31, 1996)

Patent Document 2

JP-A Publication No. S58-43295 (published on Sep. 26, 1983)

### DISCLOSURE OF THE INVENTION

### Problem to be Solved by the Invention

However, the conventional film rolls described above have the following problem.

Specifically, with the film roll disclosed in patent document 2 above, an opening must be formed near the terminal end of the film in order to hold the terminal end of the film in place, which may damage the film when a portion of the film is cut to form such an opening.

In view of the above, an object of the present invention is to provide a film roll in which the terminal end of the film can be temporarily held in place and can also be easily peeled off without damaging the film.

### Means of Solving the Problem

A film roll according to a first aspect of the present invention is loaded into a packaging machine as a packaging material for packaging products, the film roll comprising a length of film for packaging products, a core around which the length of film is wound, and an adhesive member. The adhesive member is provided between a terminal end portion of the film and a portion of the film on which the terminal end portion overlaps, in order to temporarily hold the terminal end in place. Further, the adhesive member is formed such that it increases in thickness in the direction toward the terminal end.

Here, in the film roll that is formed by winding a length of film to be loaded into a packaging machine, the adhesive member is disposed between a terminal end portion of the film and a portion of the film on which the terminal end portion overlaps in order to temporarily hold in place the terminal end of the film at the outermost convolution of the film roll, which is the first portion of the film to be pulled out from the film roll by the packaging machine. Further, with the film roll of the present invention, the adhesive member is formed such that it increases in thickness in the direction toward the terminal end of the film.

Accordingly, the terminal end of the film rises a few millimeters above the roll unit because of the adhesive member that increases in thickness in the direction toward the terminal end. Therefore, when automatically replacing the film roll, the terminal end of the film rising above the roll unit can be automatically peeled off by the packaging machine, and the film can be conveyed to a film splice device such as an autosplicer. As a result, it is possible to provide a film roll that does not need to be processed, and yet enables the terminal end of the film to be easily and mechanically peeled off by the packaging machine compared to conventional film rolls. Therefore, adopting the present invention to a packaging machine that automatically joins films is effective, especially in terms of improving operational efficiency.

In addition, since the adhesive member is formed such that it increases in thickness toward the terminal end of the film, it is possible to minimize the amount that a portion of the film, excluding the terminal end thereof, rises above the film roll. Therefore, it is possible to prevent problems, such as loosening of the film or damage to the film, which may occur during conveyance of the film roll.

Note that the terminal end portion of the film here refers to a band-shaped portion having a width of a few centimeters, which is parallel to the terminal end of the film. The terminal end of the film refers to the end of the length of film at the outermost convolution of the film roll wound around the core.

A film roll according to a second aspect of the present invention is the film roll according to the first aspect of the present invention, wherein the adhesive member is a double-sided tape.

Here, a double-sided tape is used as the adhesive member for temporarily holding the terminal end of the film in place.

Consequently, the terminal end of the film can be temporarily held in place with an easy and inexpensive means. Note that it is preferable that the adhesive member for temporarily holding the film in place is a low viscosity adhesive which provides adhesion that is not as strong as regular double-sided tape. Accordingly, the terminal end of the film can be reliably temporarily held in place and be easily pulled out after the film roll is automatically loaded into the packaging machine.

A film roll according to a third aspect of the present invention is the film roll according to the first aspect of the present invention, wherein the adhesive member comprises a plurality of micro-suction cups.

Here, the adhesive member for temporarily holding the terminal end of the film in place comprises a plurality of micro-suction cups. Accordingly, the terminal end of the film can be easily temporarily held with adequate adhesion and also be easily pulled out without any residual adhesive remaining on the film.

A film roll according to a fourth aspect of the present invention is the film roll according to any one of the first through third aspects of the present invention, wherein the adhesive member is formed such that the area in contact with the film decreases in size toward the terminal end of the film.

Here, the adhesive member is formed such that the area in contact with the film decreases in size in the direction toward the terminal end of the film. Accordingly, adhesion becomes weaker toward the terminal end of the film, and the terminal end of the film can be easily pulled out when the terminal end of the film is pulled out.

A film roll according to a fifth aspect of the present invention is the film roll according to any one of the first through fourth aspects of the present invention, wherein the adhesive member has a surface in contact with the terminal end portion side of the film and a surface in contact with a portion of the film on which the terminal end portion overlaps, and either one of the surfaces has weaker adhesion than the other surface.

Here, of the surfaces of the adhesive member in contact with the film, the level of adhesion will be different between one surface in contact with the terminal end portion side of the film and the other surface in contact with the film roll side (the side having a portion of the film on which the terminal end portion overlaps).

In this way, by weakening the adhesion on one of the surfaces in contact with the film, the terminal end of the film that is temporarily held in place can be easily released and pulled out.

### EFFECTS OF THE INVENTION

The present invention provides a film roll that does not need to be processed, and yet enables the terminal end of the film to be easily and mechanically peeled off by the packaging machine compared to conventional film rolls.

### BRIEF DESCRIPTION OF THE DRAWINGS

FIG. 1 is a schematic perspective view of a bag packaging machine and a weighing machine according to an embodiment of the present invention.

FIG. 2 is a control block diagram of the bag packaging machine.

FIG. 3 is a perspective diagram schematically illustrating a bag packaging unit of the bag packaging machine.

FIG. 4 is a partial perspective side view of a transverse sealing mechanism.

FIG. 5 is a plan view of the transverse sealing mechanism.

FIG. 6 is a sectional side view illustrating an internal configuration of a film supply unit included in the bag packaging machine shown in FIG. 1.

FIG. 7 is an enlarged view of section A in FIG. 6.

FIG. 8(a) is a perspective view illustrating the configuration of a film roll to be loaded into the bag packaging machine according to an embodiment of the present invention.

FIG. 8(b) is a sectional side view illustrating the film roll shown in FIG. 8(a).

FIG. 9 is a perspective view illustrating an example of a film roll according to another embodiment of the present invention.

FIG. 10 is a perspective view illustrating another example of a film roll according to another embodiment of the present invention.

FIG. 11(a) and FIG. 11(b) are perspective views illustrating conventional film rolls.

### DESCRIPTION OF THE REFERENCE SYMBOLS

3 bag packaging machine (packaging machine)
5 bag packaging unit
6 film supply unit
6a delivery motor
6b pawl member
6c autosplicer
6d pair of conveying belts
9 film roll
9a paper tube (core)
9b adhesive member
9d adhesive member
13 formation mechanism
15 vertical sealing mechanism
17 transverse sealing mechanism
90 control device
F film
F0 beginning end
F1 terminal end

### DETAILED DESCRIPTION OF THE INVENTION

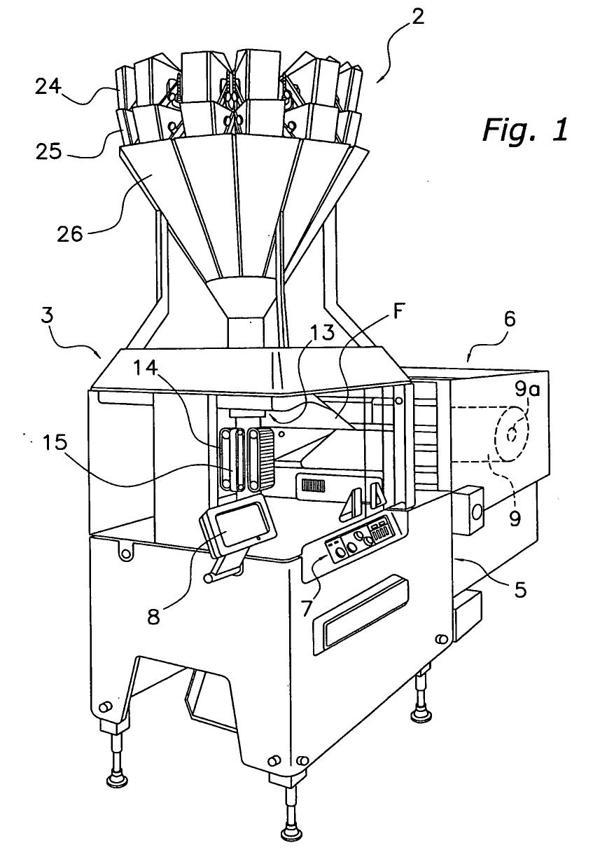

A bag packaging machine loaded with a film roll according to an embodiment of the present invention will now be described with reference to FIG. 1 through FIG. 8(b).

Note that regarding a film roll 9 which will be described in a later part of the following description, one end of a film F, which is the starting point of the winding around a paper tube (core) 9a, is referred to as a beginning end F0, and the other end of the film F at the outermost convolution of the film roll 9 when the film F is completely wound around the paper tube 9a is referred to as an terminal end F1.

### Configuration of Bag Manufacturing Packaging Apparatus 3

As shown in FIG. 1, a vertical bag packaging machine 3 according to an embodiment of the present invention is a machine in which potato chips or other food products to be packaged are wrapped with a film formed into a tubular shape, and then sealed lengthwise and widthwise so as to manufacture a bag.

The material to be packaged is basically dropped in a predetermined quantity from a weighing machine 2 provided above the bag packaging machine 3. The weighing machine 2 is a combination weighing machine that includes a feeder, a pool hopper 24, a weighing hopper 25, and a collecting and discharging chute 26.

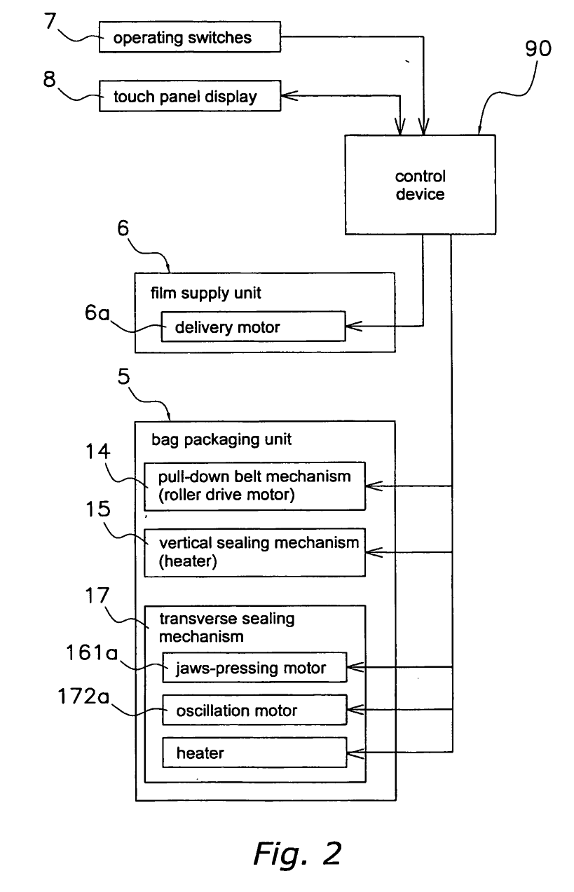

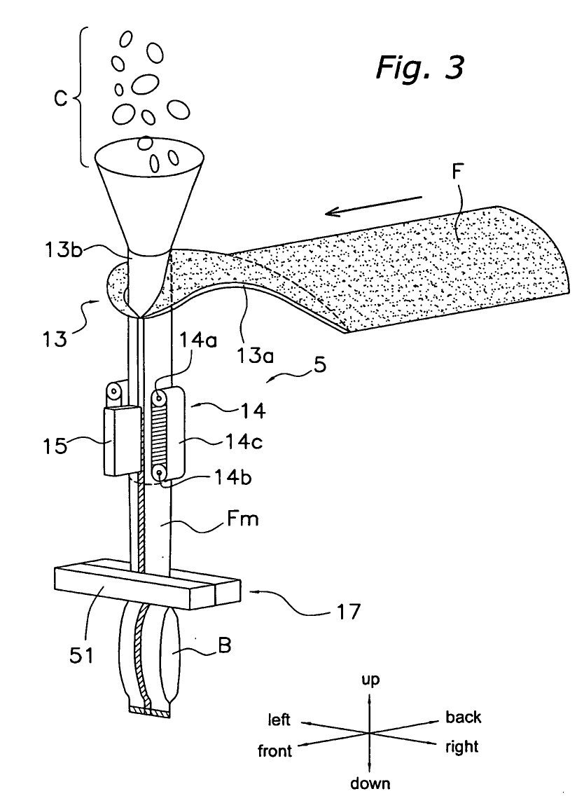

The bag packaging machine 3 includes a bag packaging unit 5 (see FIG. 3), which is the main portion that bags the material to be packaged, a film supply unit 6 that supplies a film F to be made into a bag to the bag packaging unit 5, and a control unit 90 (see FIG. 2) that controls the movement of the drive portions of the bag packaging unit 5 and the film supply unit 6.

### Film Supply Unit 6

The film supply unit 6 is a unit that supplies the film F in sheet form to a forming mechanism 13 (see FIG. 3) of the bag packaging unit 5, and is disposed adjacent to the bag packaging unit 5. With this film supply unit 6, after a film roll 9 formed by winding the film F is conveyed from a stockroom by a conveying device which is not shown, the film roll 9 is loaded therein, and the film F is unreeled from the film roll 9.

The film F unreeled from the film roll 9 is delivered by operation of a delivery motor 6a (see FIG. 2) that rotates the film roll 9, and is pulled and conveyed to the bag packaging unit 5 by operation of a pair of conveying belts 6c and a pull-down belt mechanism 14 of the bag packaging unit 5, which will be described below.

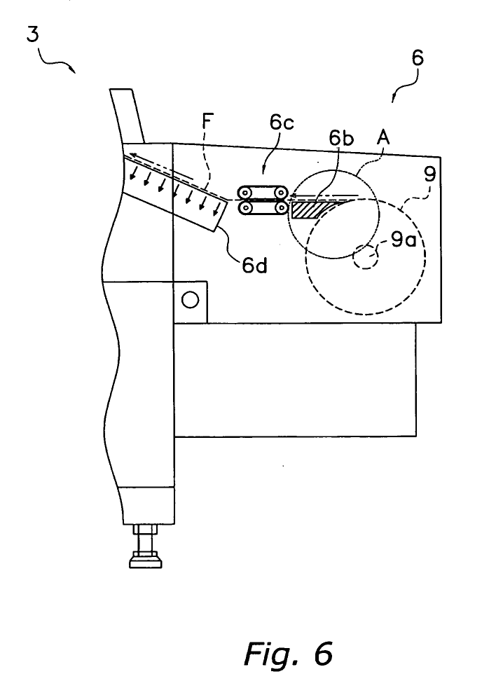

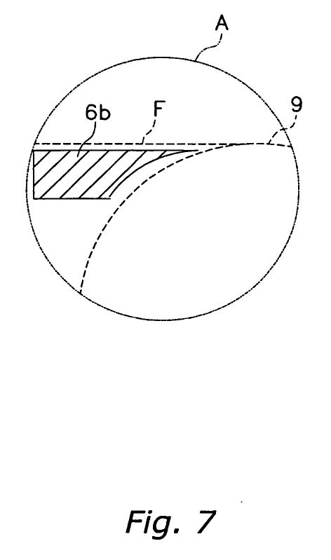

In addition, as shown in FIGS. 6 and 7, the film supply unit 6 includes: a pawl member 6b for automatically pulling out the end of the film F, i.e., the terminal end F1 of the film F from the film roll 9; the pair of conveying belts 6c that convey the terminal end F1 of the film F that is pulled out from the film roll 9 by means of the pawl member 6b to an autosplicer 6d; and the autosplicer (film splice device) 6d that joins the beginning end F0 of the film F of a film roll that was immediately previously loaded and the terminal end F1 of a film roll 9 that is newly loaded to replace the old film roll.

As shown in FIG. 7, the pawl member 6b is disposed such that the distal end thereof is capable of moving to a position close to the film surface of the film roll 9. As a new film roll 9 is loaded, the distal end of the pawl member 6b is moved to the position close to the film surface of the film roll 9. In this state, the film roll 9 is rotated by the delivery motor 6a, and consequently it will be possible to automatically pull out the terminal end F1 of the film F rising about 0.5 mm to 1.0 mm above the film surface of the film roll 9 from the film roll 9 because of an adhesive member 9b that will be described below.

The pair of conveying belts 6c use two conveying belts together, which comprise a drive roller, a driven roller, and a annular belt to sandwich the film F between the two conveying belts and convey the film F. The pair of conveying belts 6c sandwiches the terminal end F1 of the film which was pulled out from the film roll 9 by means of the pawl member 6b, and conveys the film F to the autosplicer 6d (in the direction of the dashed line arrow shown in FIG. 6).

The autosplicer 6d draws the end (beginning end F0) of the film F by suction and closely holds the end thereof in the direction of the solid arrow shown in FIG. 6, when all the film F is delivered from the film roll 9. Then, the film F pulled out from a newly loaded film roll 9 is also drawn by suction and closely held in the direction of the same solid arrow shown in FIG. 6. Subsequently, the beginning end F0 of the film F of the previously loaded film roll 9 and the terminal end F1 of the film F of the newly loaded film roll 9 are automatically joined together. In this way, the very end (beginning end F0) of the immediately previously loaded film roll 9 is joined to the terminal end F1 of the newly loaded film roll 9. Consequently, it will be possible to continuously supply the film F to the bag packaging machine 3 even when the film roll 9 is replaced.

Note that the configuration of the film roll 9 will be described below.

### Bag Manufacturing Packaging Unit 5

As shown in FIG. 3, the bag packaging unit 5 has a forming mechanism 13 that forms the film F that is delivered in a sheet form into a tubular shape, a pull-down belt mechanism 14 that conveys the tubular-shaped film F (hereinafter referred to as tubular film Fm) downward, a vertical sealing mechanism 15 that seals the overlapping portions of the tubular film Fm lengthwise, and a transverse sealing mechanism 17 that seals the top and bottom ends of the bag B by sealing the tubular film Fm widthwise.

### Forming Mechanism 13

The forming mechanism 13 has a tube 13b and a former 13a. The tube 13b is a cylindrical-shaped member and is open at the top and bottom ends. A material to be packaged C that has been weighed by the weighing machine 2 is dropped into the opening at the top end of the tube 13b. The former 13a is disposed so as to enclose the tube 13b. The shape of the former 13a is formed such that the sheet-like film F that is unreeled from the film roll 9 is formed into a tubular shape as the film F passes between the former 13a and the tube 13b (see FIG. 3). In addition, the tube 13b and the former 13a of the forming mechanism 13 can be replaced with ones with different sizes, according to the size of the bags to be manufactured.

### Pull-Down Belt Mechanism 14

The pull-down belt mechanism 14 is a mechanism in which the tubular film Fm wound around the tube 13b is held by suction and conveyed downward. As shown in FIG. 3, the pull-down belt mechanism 14 has belts 14c that sandwich the tube 13b from both the left and right sides. With the pull-down belt mechanism 14, the belts 14c, which function to hold the film F by suction, are rotated by a driving roller 14a and a driven roller 14b so as to convey the tubular film Fm downward. Note that in FIG. 3, an illustration of a roller drive motor that rotates the driving roller 14a and the other members has been omitted.

### Vertical Sealing Mechanism 15

The vertical sealing mechanism 15 is a mechanism that heats and seals lengthwise the overlapping portions of the tubular film Fm that is wound around the tube 13b, while pressing the overlapping portions against the tube 13b with a specific amount of pressure. This vertical sealing mechanism 15 is positioned on the front side of the tube 13b, and has a heater, and a heater belt that is heated by the heater, and comes in contact with the overlapping portions of the tubular film Fm. Although not shown in the figure, the vertical sealing mechanism 15 also has a drive apparatus for moving the heater belt toward and away from the tube 13b.

### Transverse Sealing Mechanism 17

The transverse sealing mechanism 17 is disposed underneath the forming mechanism 13, the pull-down belt mechanism 14, and the vertical sealing mechanism 15. The transverse sealing mechanism 17 is a mechanism that includes a pair of sealing jaws 51 that accommodate the heater (see FIG. 3).

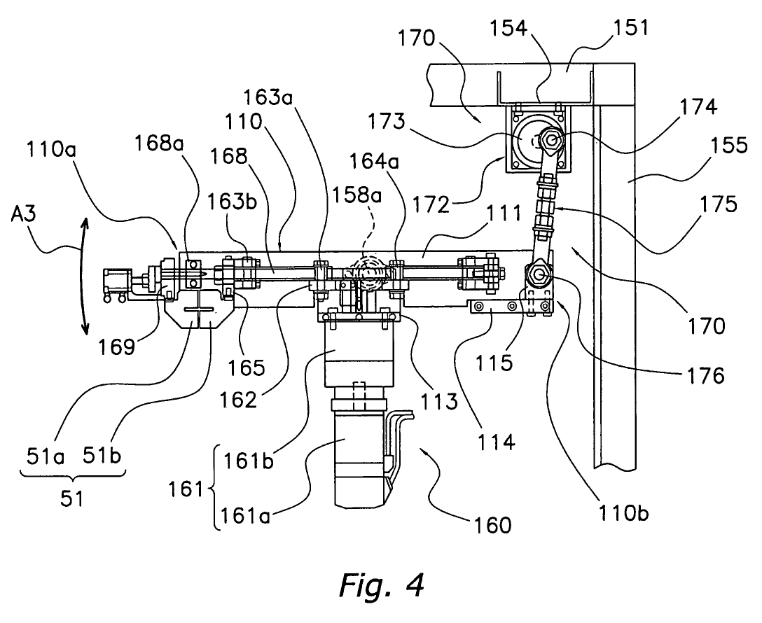

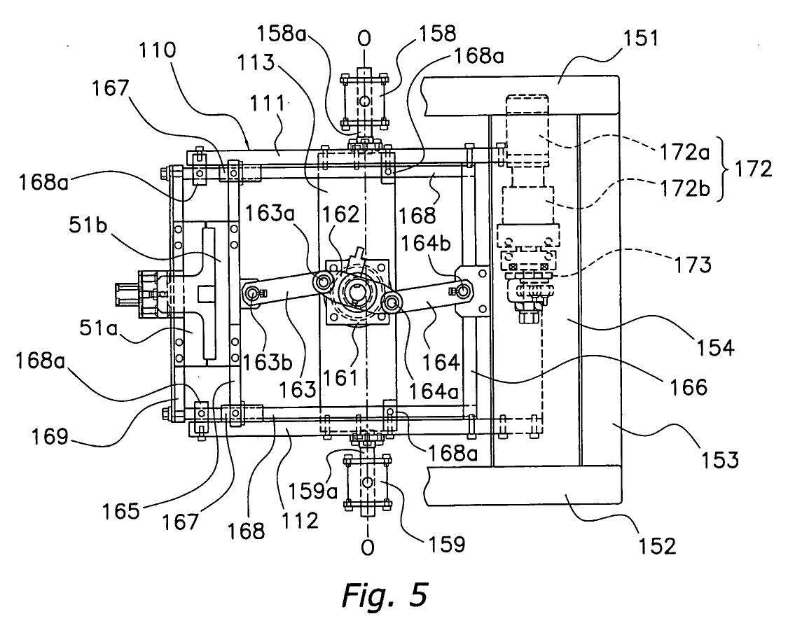

Although an illustration thereof has been omitted in FIG. 3, as shown in FIGS. 4 and 5, the transverse sealing mechanism 17 further comprises a sealing jaws moving mechanism 160 that move the pair of sealing jaws 51 toward and away from each other; an oscillating carriage 110 on which the sealing jaws moving mechanism 160 and the sealing jaws 51 are mounted; and an oscillation mechanism 170 that rotates (oscillates) the oscillating carriage 110 about the rotational axis O-O.

The pair of sealing jaws 51 includes a front sealing jaw 51a and a back sealing jaw 51b. The pair of sealing jaws 51 is supported at a front end portion 110a of the oscillating carriage 110 such that the front sealing jaw 51a and the back sealing jaw 51b are located respectively in front and back of the tubular film Fm. As described below, the pair of sealing jaws 51 is configured to press against each other to hold the tubular film Fm therebetween and to seal, by application of pressure and heat, the portions of the tubular film Fm that will be the top and bottom ends of the bags.

In addition, the inside of one of the sealing jaws 51 has a built-in cutter, which is not shown. This cutter is positioned at the center of the transverse sealing portion of the sealing jaws 51 in the height direction, and serves to cut the bag B away from the following tubular film Fm.

The oscillating carriage 110 is pivotally supported by bearings 158, 159 such that the oscillating carriage 110 rotates about the rotational axis O-O (see FIG. 5). Specifically, a left oscillation axis member 158a and a right oscillation axis member 159a that respectively extend to the left and right from the oscillating carriage 110 are pivotally supported by the bearings 158, 159. The oscillating carriage 110 extends substantially horizontally forward and backward from the rotational axis O-O. The sealing jaws 51 are disposed at the front end portion 110a, and a force receiving unit 115 that receives the force of a rod 175 of the oscillation mechanism 170 is disposed at a back end portion 110b.

The oscillating carriage 110 mainly comprises left and right frames 111, 112, and coupling members 113, 114 which couple the left and right frames 111, 112 at the center and rear thereof. The force receiving unit 115 is fixed to the coupling member 114, specifically at the horizontal central portion of the coupling member 114 (see FIG. 4). In addition, a left oscillation axis member 158a and a right oscillation axis member 159a are respectively fixed to the left and right frames 111, 112, specifically at the outer sides of the central portions of the left and right frames 111, 112 in the front and back direction.

The sealing jaws moving mechanism 160 is a mechanism configured to move the pair of sealing jaws 51 such that they come in contact with and move away from the tubular film Fm, and the sealing jaws moving mechanism 160 is incorporated in the oscillating carriage 110. The sealing jaws moving mechanism 160 mainly comprises a drive unit 161, and a linking mechanism that converts the rotational force from the drive unit 161 into a reciprocating forward and backward motion of the front sealing jaw 51a and the back sealing jaw 51b. This linking mechanism mainly comprises a rotation plate 162; a front coupling member 163; a back coupling member 164; a back sealing jaw fixing member 165; a horizontal connecting bar 166; front and back bars 168 that extend forward from both the left and right ends of the horizontal connecting bar 166; and a front sealing jaw fixing member 169 that couples the front and back bars 168 at their ends.

The drive unit 161 is formed by a jaw pressing motor 161a and a speed reducer 161b, and is disposed lengthwise such that the rotary shaft extends in the vertical direction. The drive unit 161 includes a mounting plate on the speed reducer 161b that is disposed on the top side of the jaws-pressing motor 161a. The mounting plate is fastened by a bolt at the central portion of the coupling member 113 of the oscillating carriage 110. In other words, the drive unit 161 is fixed so as to hang from substantially the central portion of oscillating carriage 110. In addition, as clearly shown in FIG. 5, the jaw pressing motor 161a and the speed reducer 161b of the drive unit 161 are located under the rotational axis O-O. In other words, the jaw pressing motor 161a and the speed reducer 161b of the drive unit 161 overlap with the rotational axis O-O when viewed in plan.

The rotation plate 162 is fixed to an output rotary shaft that protrudes from the top of the speed reducer 161b of the drive unit 161. The front coupling member 163 is pivotally supported by a pin member 163a at one end of a rotation plate 162, and the back coupling member 164 is pivotally supported by a pin member 164a at the other end of the rotation plate 162. The horizontal central portion of the back sealing jaw fixing member 165 is supported at a front end of the front coupling member 163 by a pivotal pin member 163b, and the both left and right ends of the back sealing jaw fixing member 165 are fixed to the slide members 167 that can slide forward and backward along the front and back bars 168. Further, the back sealing jaw 51b is fixed to the back sealing jaw fixing member 165. The horizontal central portion of the horizontal connecting bar 166 is pivotally supported at a rear end of the back coupling member 164 by a pin member 164b. Each of the front and back bars 168 extends forward from both left and right ends of the horizontal connecting bar 166. These front and back bars 168 are supported by four slide supporting members 168a that are fixed to the central portions and the front portions of the left and right frames 111, 112 of the oscillating carriage 110 such that the front and back bars 168 are capable of freely sliding forward and backward along the oscillating carriage 110. Further, the front sealing jaw fixing member 169 extends horizontally so as to couple the distal ends of the front and back bars 168 on the left and right sides of the front sealing jaw fixing member 169, and fixes the front sealing jaw 51a in place.

The oscillation mechanism 170 imparts a vertical reciprocating force on the oscillating carriage 110, and as shown by arrow A3 in FIG. 4, the oscillation mechanism 170 rotates (oscillates) the oscillating carriage 110 about the rotational axis O-O. This oscillation mechanism 170 mainly comprises an oscillation drive unit 172 and a crank mechanism that converts the rotational force of the oscillation drive unit 172 into a vertical reciprocating motion. The crank mechanism mainly comprises an off-center support board 173 and a rod 175.

The oscillation drive unit 172 comprises an oscillation motor 172a and a speed reducer 172b. The oscillation drive unit 172 is fixed to the fixing member 154 so as to hang therefrom so that the rotary shaft of the oscillation drive unit 172 extends horizontally. Both left and right ends of the fixing member 154 are respectively fixed to beam members 151, 152, and the beam members 151, 152 are integrated with a fixing frame of the bag packaging machine 3 via different beam members 153, 155, and the like.

Fixed to the output rotary shaft of the speed reducer 172b of the oscillation drive unit 172 is an off-center support board 173 shown in FIG. 4. On one side of the off-center support board 173, the central portion thereof is fixed to the output rotary shaft of the speed reducer 172b. On the opposite side, the off-center support board 173 pivotally supports an upper end of the rod 175 via a pin member 174 at a position deviated from the central portion, i.e., the center of rotation of the off-center support board 173. Therefore, when the off-center support board 173 rotates, the upper end of the rod 175 will revolve around the center of rotation of the horizontally disposed oscillation drive unit 172. On the other hand, a lower end of the rod 175 is pin-supported by a force receiving unit 115 of the oscillating carriage 110 via a pin member 176. This force receiving unit 115 is capable of freely revolving about the rotational axis O-O of the oscillating carriage 110. Thus, when the oscillation motor 172a is actuated and the off-center support board 173 starts rotating, the rod 175 moves the force receiving unit 115 in the vertical direction, and the oscillating carriage 110 starts rotating about the rotational axis O-O.

Note that the rod 175 can be manually extended and retracted, and the angle of rotation of the oscillating carriage 110 can be changed by adjusting the length of the rod 175. In this way, by changing the angle of rotation of the oscillating carriage 110, ultimately it will be possible to change the distance of vertical movement of the sealing jaws 51 that are disposed at the front end portion 110a of the oscillating carriage 110.

### Control Device 90

The control device 90 performs various types of control for the weighing machine 2 and the bag packaging machine 3. The control device 90 comprises a CPU, ROM, RAM, and the like. According to operations and settings inputted from operating switches 7 and a touch panel display 8 shown in FIGS. 1 and 2, the control device 90 controls the delivery motor 6a that rotates the film roll 9 in the film supply unit 6 in order to unreel the film F, the drive portion of each mechanism of the bag packaging unit 5, and the like. In addition, the control device 90 controls the driving of the feeder of the weighing machine 2, the pool hopper 24, the weighing hopper 25, and the like. Further, the control device 90 acquires necessary information from the sensors in the weighing machine 2 and the bag packaging machine 3, and uses this information in the various types of control.

In addition to controlling the continuous operation for continuous weighing, bag manufacturing, and packaging, the control device 90 can also control an intermittent operation for intermittent weighing, bag manufacturing, and packaging. In the intermittent operation control, the film F is intermittently supplied from the film supply unit 6 to the bag packaging unit 5 in the bag packaging machine 3, and the bags are intermittently manufactured in the bag packaging unit 5.

Further, when the control device 90 controls the oscillation motor 172a of the oscillation mechanism 170, the control device 90 will repeat a first control mode for rotating the oscillation motor 172a in a forward direction and a second control mode for rotating the oscillation motor 172a in a reverse direction. However, if it is possible to achieve appropriate oscillation control with only one of the first control mode or the second control mode, oscillation control will be performed in order to keep the oscillation motor 172a rotating in the same direction.

### Film Roll 9

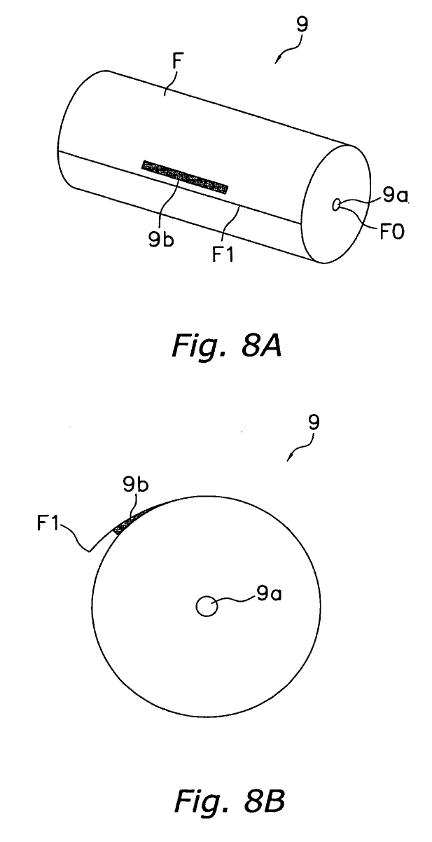

In the present embodiment, the film roll 9 such as the one shown in FIG. 8(a) or FIG. 8(b) is used as a film roll to be loaded into the bag packaging machine 3.

Specifically, the film roll 9 of the present embodiment comprises a length of film F that is wound around a paper tube 9a, and an adhesive member 9b having a plurality of micro-suction cups on both surfaces thereof for temporarily holding the terminal end F1 of the film F in place. By temporarily holding the terminal end F1 of the film F with respect to the film roll 9, it is possible to prevent a problem caused by the terminal end F1 of the film F becoming separated from the film roll 9 during conveyance of the film roll 9.

As shown in FIGS. 8(a) and 8(b), an adhesive member 9b for temporarily holding the terminal end F1 of the film F in place is disposed between the reverse side of a portion (the side that touches the film F) that is within 10-20 from the terminal end F1 of the film F (toward the upstream in the conveying direction of the film F, i.e., toward the beginning end F0 of the film F) and the front side of a portion of the film roll 9 on which the terminal end F1 overlaps (the side that touches the terminal end F1 portion). As shown in FIG. 8(b), the adhesive member 9b is formed so as to increase in thickness in the direction from the inside of the film roll 9 toward the terminal end F1. Therefore, in the film roll 9 of the present embodiment, the terminal end F1 of the film F can be raised up from the film surface of the film roll 9 by about 0.5 to 1.0 mm. In addition, the adhesive member 9b is not uniform in thickness, but rather the thickness thereof increases toward the terminal end F1. Therefore, it is possible to prevent a portion of the film F inward of where the adhesive member 9b is attached from becoming raised up from the surface of the film roll 9, and consequently instances of the film F becoming damaged and other such problems can be avoided. Accordingly, only the terminal end F1 is raised up from the film surface of the film roll 9 by the amount minimally necessary, and it will consequently be possible to obtain a film roll 9 which is easily pulled out without damaging the film F of the film roll 9.

It is possible to use a micro-suction cup sheet having a 100 to 500 μm thickness as the adhesive member 9b, which is formed by introducing numerous fine air bubbles into a resin such as acrylic emulsion resin. The adhesive member 9b having this type of structure will temporarily hold the terminal end F1 of the film F in place with a low viscosity adhesive that has weaker adhesion than a regular adhesive tape. Accordingly, in regular use, it is possible to prevent the terminal end F1 of the film F from being peeled off from the film roll 9. Meanwhile, once the film roll 9 is loaded, it is possible to hold the terminal end F1 on the film roll 9 with adhesion such that the terminal end F1 of the film F can be easily peeled off from the film roll by means of the pawl member 6b.

Note that the above-described micro-suction cup sheet is more advantageous than an adhesive material such as a regular double-sided tape, because the terminal end F1 of the film F can be temporarily held in place repeatedly with adequate adhesion and residual adhesive will not remain on the film F.

### Characteristics of the Film Roll 9

(1) The film roll 9 in this embodiment is a film roll formed by winding a length of film F around the paper tube 9a, and is automatically loaded into the bag packaging machine 3. With this film roll 9, the adhesive member 9b for temporarily holding the terminal end F1 of the film F in place is disposed at a portion within 10-20 mm from the terminal end F1 of the film F, and between the reverse side of the terminal end F1 portion and the front side of a portion of the film F on which the terminal end F1 overlaps. The adhesive member 9b is formed so as to increase in thickness from the inside of the film F toward the terminal end F1.

Accordingly, the terminal end F1 of the film F can be raised up from the film surface of the film roll 9 by about 0.5 to 1.0 mm. Therefore, compared to a film roll in which the terminal end of the film is temporarily held in place with a conventional adhesive tape, the film roll 9 allows the terminal end F1 of the film to be easily and automatically pulled out by the bag packaging machine 3 by means of the pawl member 6b and the like. In addition, even if the adhesive member 9b is inserted underneath the terminal end F1 portion of the film roll 9, since the adhesive member 9b is formed such that it increases in thickness from the inside of the film F1 toward the terminal end F1, it is possible to prevent a portion of the film F, excluding the terminal end F1, from rising above the surface of the film F. Therefore, the terminal end F1 of the film F is raised up only by the amount minimally necessary, and it will consequently be possible to avoid a problem such as loosening of the film F. Further, since the terminal end of the film F does not need to be processed, the risk of damaging the film F will be avoided, and it is consequently possible to provide a film roll that is suitable for a bag packaging machine 3 in which the processes from automatically loading the film roll 9 to starting the operation of the machine are automated.

(2) With the film roll 9 in this embodiment, a micro-suction cup sheet that is formed by introducing numerous fine air bubbles into a resin such as acrylic emulsion resin is used as the adhesive member 9b.

Accordingly, the terminal end F1 of the film F can be temporary held on the surface of the film F repeatedly with adequate adhesion. Further, since adhesion is provided by the suction cups, it is possible to prevent residual adhesive from remaining on the film F, unlike a case in which a double-sided tape is used as an adhesive member.

### Other Embodiments

An embodiment of the present invention was described above, but the present invention is not limited to this embodiment, and various modifications can be made within a range that does not deviate from the scope of the invention.

(A) The above embodiment is described using an example in which the terminal end F1 of the film F of the film roll 9 is temporarily held in place by the micro-suction cups of the adhesive member 9b. However, the present invention is not limited thereto.

For example, it is possible to use a low viscosity double-sided tape instead of the micro-suction cups. Consequently, it will be possible to temporarily hold the terminal end of the film roll 9 using an adhesive member that is relatively inexpensive compared to the micro-suction cups. Note that, when using a double-sided tape as an adhesive member, it is preferable to use a low viscosity double-sided tape that has weaker adhesion than regular double-sided tape. Consequently, it will be possible to easily pull out the terminal end F1 of the film F from the film roll 9.

However, as in the above embodiment 1, it is especially preferable to use micro-suction cups for temporarily holding the terminal end F1 of the film roll 9, because the terminal end F1 can be temporary held in place repeatedly with adequate adhesion and residual adhesive will not remain on the film F.

(B) The above embodiment is described using an example in which the adhesive member 9b is rectangular in plan view. However, the present invention is not limited thereto.

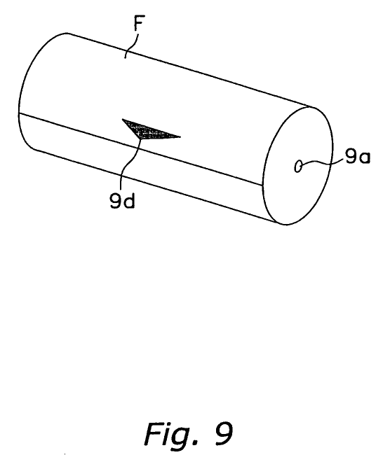

For example, as shown in FIG. 9, an adhesive member 9d that is triangular in plan view may be used. The adhesive member 9d shown in FIG. 9 is formed such that the apex of the triangle faces the terminal end F1 of the film F. In this way, since the adhesive member 9d is disposed such that the adhesion area decreases in size in the direction toward the terminal end F1 of the film F, the adhesion thereof will weaken from the downstream side to the terminal end F1. Accordingly, the terminal end F1 can be more easily pulled out from the film roll 9.

(C) In the above embodiment, a detailed description is not provided regarding the strength of adhesion of the micro-suction sheet used as the adhesive member 9b on the front and reverse sides of the film F. However, the side that comes in contact with the terminal end F1 portion and the side that comes in contact with the film F may have a different level of adhesive strength.

In such a case, since one side has weaker adhesion than the other side, the terminal end F1 can be easily pulled out from the film roll 9 by means of the pawl member 6b.

(D) The above embodiment is described using an example in which the terminal end F1 of the film F of the film roll has a linear shape. However, the present invention is not limited thereto.

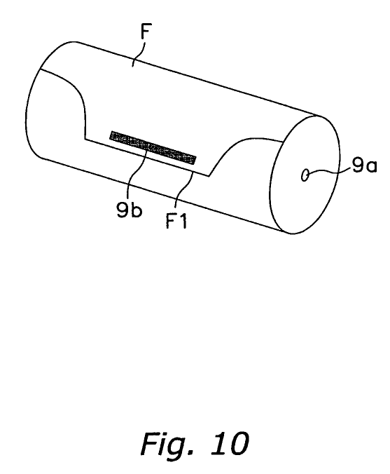

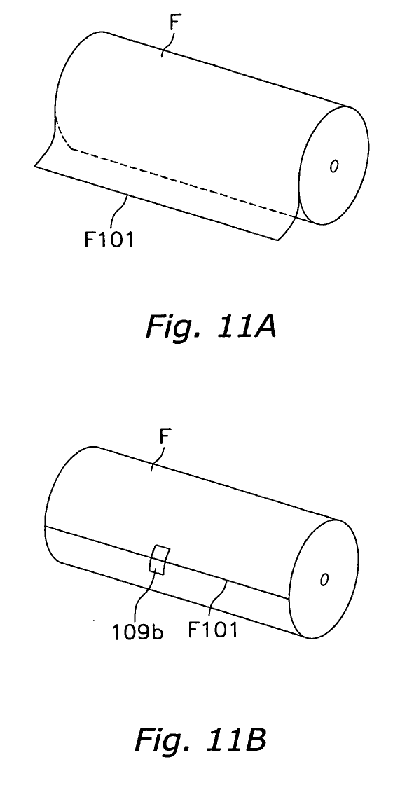

For example, in order to enable the film to be easily pulled from the film roll, a film roll as shown in FIG. 10 may be used in which the terminal end F1 of the film is formed in a shape such that both side portions of the terminal end are cut out and only the central portion thereof is left.

### INDUSTRIAL APPLICABILITY

The film roll of the present invention does not need to be processed, and yet the terminal end of the film thereon can be easily and mechanically peeled off by a packaging machine. Because of this effect, in particular, the film roll of the present invention is widely applicable to packaging machines in which processes from loading a film roll to a setting the film roll are automated.

1. A film roll to be loaded into a packaging machine as a packaging material for packaging a product, comprising:
a length of film for packaging the product;
a core around which the length of film is wound; and
an adhesive member that is provided between a terminal end portion of the film and a portion of the film on which the terminal end portion overlaps in order to temporarily hold the terminal end portion of the film in place, the adhesive member formed so as to increase in thickness toward the terminal end portion of the film.

2. The film roll according to claim 1, wherein
the adhesive member is a double-sided tape.

3. The film roll according to claim 1, wherein
the adhesive member is comprised of micro-suction cups.

4. The film roll according to claim 1, wherein
the adhesive member is formed such that the area thereof in contact with the film decreases in size toward the terminal end portion of the film.

5. The film roll according to claim 1, wherein
the adhesive member comprises a surface in contact with the terminal end portion of the film, and a surface in contact with a portion of the film on which the terminal end portion overlaps, and either one of the surfaces of the adhesive member has weaker adhesion than the other surface.
